(19) United States
(12) Patent Application Publication
(10) Pub. No.: US 2023/0186629 A1
(43) Pub. Date: Jun. 15, 2023

(54) AUTOMATICALLY FORMING AND USING A LOCAL NETWORK OF SMART EDGE DEVICES

(71) Applicant: Microsoft Technology Licensing, LLC, Redmond, WA (US)

(72) Inventors: Debasish MUKHOPADHYAY, Sammamish, WA (US); Bhairav Harishkumar MEHTA, San Jose, CA (US); Hermineh SANOSSIAN, Kirkland, WA (US); Devpal Bapusaheb KHOT, Bothell, WA (US); Vadim Sergeyevich SMOLYAKOV, Renton, WA (US); Huinan LIU, Clyde Hill, WA (US)

(21) Appl. No.: 17/548,009

(22) Filed: Dec. 10, 2021

(51) Int. Cl. G06V 20/40; H04N 7/18; G06V 40/20

(52) U.S. Cl. CPC G06V 20/44; H04N 7/181; G06V 20/41; G06V 40/23; G01S 5/02521

(57) ABSTRACT

Forming and using a local network of smart edge sensor devices. After identifying a first smart edge device within a physical space, a computer system inserts a coordinate of the first smart edge device into a spatial map associated with the physical space and identifies a normal environmental state for the first smart edge device. After identifying a second smart edge device within the physical space, the computer system identifies a position of the second smart edge device relative to the first smart edge device based on signals generate by the first and/or second smart edge devices, inserts a coordinate of the second smart edge device into the spatial map, and identifies a normal environmental state for the second smart edge device. Based on monitoring signal streams generated by the first and second smart edge devices, the computer system identifies intent(s) associated with an object positioned within the physical space.

### BACKGROUND

Internet of Things (IoT) devices are computing devices that connect to a wired or wireless network, and then communicate directly with Internet servers (e.g., “the cloud”). While IoT devices can provide a variety of functionality, some IoT devices include one or more sensors—such as digital imaging (i.e., camera), temperature, sound, and the like. Thus, IoT devices send raw feeds of captured sensor data directly to Internet servers. Those servers, in turn process and potentially act on the captured sensor data (e.g., to store at least a portion of the data, to generate alerts based on the data, etc.). For example, an IoT device containing a digital imaging sensor and a microphone sends raw audiovisual data to a cloud server, and the cloud server processes and acts on that audiovisual data.

As IoT devices have proliferated, there have been attempts to form networks of IoT sensor devices for various purposes, such as for security monitoring, for automating the sale of physical goods, and the like. Thus, a given physical location may contain many IoT sensor devices, each of which communicates captured data to Internet servers. Those Internet servers then process and act on that data.

### BRIEF SUMMARY

The inventors have recognized that conventional IoT sensor networks present a myriad of technical and logistical challenges. For example, the inventors have recognized that, due to their cloud-based nature, conventional IoT sensor networks require significant Internet bandwidth and can have relatively high latency in their operation. For instance, if an IoT security network comprises devices that send audiovisual data to a cloud server to detect and act on security threats (e.g., to generate an alarm, to lock a door, etc.), the inherent latency of cloud communications may mean that the cloud server cannot react quickly enough to prevent or mitigate a security issue. For example, if the cloud server detects a burglary in progress, the cloud server may not be able to react quickly enough to lock a door before the burglar leaves the premises.

Additionally, the inventors have recognized that some IoT sensor networks include many devices, which presents significant challenges for forming and managing IoT sensor networks. For example, when using IoT sensor networks to automate the sale of goods by tracking a person's activity in a store, IoT sensor networks may include hundreds of IoT sensor devices, such as cameras, pressure sensors, and the like. Conventionally, these IoT sensor devices are onboarded and calibrated on an individual basis, and in a manner tailored to a given space—which consumes a great deal of time and effort both to form the IoT sensor network and to later manage the IoT sensor network (e.g., as devices are inadvertently moved or otherwise become uncalibrated). Additionally, to simplify installation and management of the IoT sensor devices, the devices may include sensors manufactured with tight tolerances, which increases the overall cost and complexity of the IoT sensor network.

At least some embodiments described herein address these, and other, challenges with methods, systems, and computer program products for automatically forming and using a local network of smart edge devices. Embodiments include an automated plug-and-play architecture for adding smart edge devices to a local network, for automatically managing (e.g., recalibrating) those smart edge devices, and for processing sensor data locally.

In embodiments, using the automated plug-and-play architecture described herein, a local management system automatically detects the presence of each new smart edge device, adds each new smart edge device to a spatial map of a local physical space (e.g., based on smart edge devices detecting one another), and determines a “normal” environmental signal state for each new smart edge device within that physical space. Thus, the embodiments herein alleviate the challenges of forming conventional IoT sensor networks, by providing an automated plug-and-play architecture that automatically discovers and adds smart edge devices to a spatial map. Additionally, by determining normal environmental signal states each smart edge device, the embodiments herein eliminate the need for devices to have sensors manufactured with tight tolerances, which decreases the overall cost and complexity of the local network of smart edge devices as compared to conventional IoT sensor networks.

In embodiments, the local management system also automatically determines when the environmental signal state for a given smart edge device has changed (e.g., due to the device having been moved), and determines a new normal environmental signal state for the smart edge device. Thus, the embodiments herein alleviate the challenges of managing conventional IoT sensor networks, by automatically recalibrating smart edge devices to adapt to gonging changes within the local network of smart edge devices.

In embodiments, smart edge devices include one or more sensors, as well as signal generating logic that processes the device's sensor data at the smart edge device, in order to generate signals from the sensor data. The smart edge devices then send these signals (rather than the raw sensor data, itself) to the local management system which, processes the signal through a local intent engine in order to act on the signals. By operating on signals, rather than raw sensor data, the local management system can quickly react to situations detected by the local network of smart edge devices. Additionally, latency and Internet bandwidth usage is reduced by processing signals locally, rather than in the cloud.

In some aspects, the techniques described herein relate to a method, implemented at a computer system that includes a processor, for forming and monitoring a network of edge sensor devices, the method including: based on identifying a first smart edge device within a physical space: inserting a first coordinate of the first smart edge device into a spatial map associated with the physical space, and based on a first sensor of the first smart edge device, identifying a first normal environmental state for the first smart edge device; based on identifying a second smart edge device within the physical space: identifying a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device, inserting a second coordinate of the second smart edge device into the spatial map associated with the physical space, and based on the second sensor of the second smart edge device, identifying a second normal environmental state for the second smart edge device; and based on at least on monitoring a first signal stream generated by the first signal generating logic, and on monitoring a second signal stream generated by the second signal generating logic, identifying a set of one or more intents associated with an object positioned within the physical space.

In some aspects, the techniques described herein relate to a computer system including: a processor; and a computer storage media that stores computer-executable instructions that are executable by the processor to cause the computer system to at least: based on identifying a first smart edge device within a physical space: insert a first coordinate of the first smart edge device into a spatial map associated with the physical space, and based on a first sensor of the first smart edge device, identify a first normal environmental state for the first smart edge device; based on identifying a second smart edge device within the physical space: identify a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device, insert a second coordinate of the second smart edge device into the spatial map associated with the physical space, and based on the second sensor of the second smart edge device, identify a second normal environmental state for the second smart edge device; and based on at least on monitoring a first signal stream generated by the first signal generating logic, and on monitoring a second signal stream generated by the second signal generating logic, identify a set of one or more intents associated with an object positioned within the physical space.

In some aspects, the techniques described herein relate to a computer program product including a computer storage media that stores computer-executable instructions that are executable by a processor to cause a computer system to at least: based on identifying a first smart edge device within a physical space: insert a first coordinate of the first smart edge device into a spatial map associated with the physical space, and based on a first sensor of the first smart edge device, identify a first normal environmental state for the first smart edge device; based on identifying a second smart edge device within the physical space: identify a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device, insert a second coordinate of the second smart edge device into the spatial map associated with the physical space, and based on the second sensor of the second smart edge device, identify a second normal environmental state for the second smart edge device; and based on at least on monitoring a first signal stream generated by the first signal generating logic, and on monitoring a second signal stream generated by the second signal generating logic, identify a set of one or more intents associated with an object positioned within the physical space.

In some aspects, identifying the set of one or more intents associated with the object positioned within the physical space includes: sending, to an artificial intelligence or machine learning model of an intent engine, at least the first signal stream and the second signal stream.

In some aspects, the first signal stream includes a first physical signal associated with the object positioned within the physical space; the second signal stream includes a second physical signal associated with the object positioned within the physical space; and identifying the set of one or more intents associated with the object positioned within the physical space includes sending, to an artificial intelligence or machine learning model of an intent engine, at least (i) the first physical signal, (ii) the second physical signal, and (iii) a digital signal associated with a non-sensor computing device.

In some aspects, in response to identifying the set of one or more intents associated with the object positioned within the physical space, embodiments determine an action based on a set of one or more rules; and embodiments automatically initiate the action.

In some aspects, based the first signal stream, embodiments detect a first object positioned within the physical space; based the second signal stream, embodiments detect a second object positioned within the physical space; and embodiments determine that the object positioned within the physical space corresponds to each of the first object and the second object.

In some aspects, embodiments determine a time series for the object positioned within the physical space, the time series including at least one of object position or object intent.

In some aspects, embodiments determine a second-level intent for the object positioned within the physical space from the set of one or more intents.

In some aspects, based on identifying a first anomalous signal from the first smart edge device, embodiments recalibrate the first normal environmental state for the first smart edge device; or based on identifying a second anomalous signal from the second smart edge device, embodiments recalibrate the second normal environmental state for the second smart edge device.

In some aspects, embodiments instantiate the spatial map prior to inserting the first coordinate of the first smart edge device into the spatial map.

In some aspects, embodiments identify a non-sensor computing device within the physical space; and embodiments insert a third coordinate of the non-sensor computing device into the spatial map associated with the physical space.

In some aspects, the first signal stream is generated by the first signal generating logic based on processing first sensor data generated by the first sensor of the first smart edge device through a first artificial intelligence or machine learning model at the first smart edge device; and the second signal stream is generated by the second signal generating logic based on processing second sensor data generated by the second sensor of the second smart edge device through a second artificial intelligence or machine learning model at the second smart edge device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment that facilitates automatically forming and using a local network of smart edge devices;

FIG. 2A illustrates an example of integration of an initial smart edge device into a physical space;

FIG. 2B illustrates an example of integration of an additional smart edge device into a physical space;

FIGS. 2C-2E illustrate examples of using a plurality of smart edge devices to detect and track a time series for a single object within a physical space;

FIGS. 2F and 2G illustrate examples of using a plurality of smart edge devices to determine actions based on an object within a physical space;

FIG. 2H illustrates an example of recalibrating a normal environmental state for a smart edge device; and

FIG. 3 illustrates a flowchart of an example method for forming and monitoring a network of smart edge sensor devices.

### DETAILED DESCRIPTION

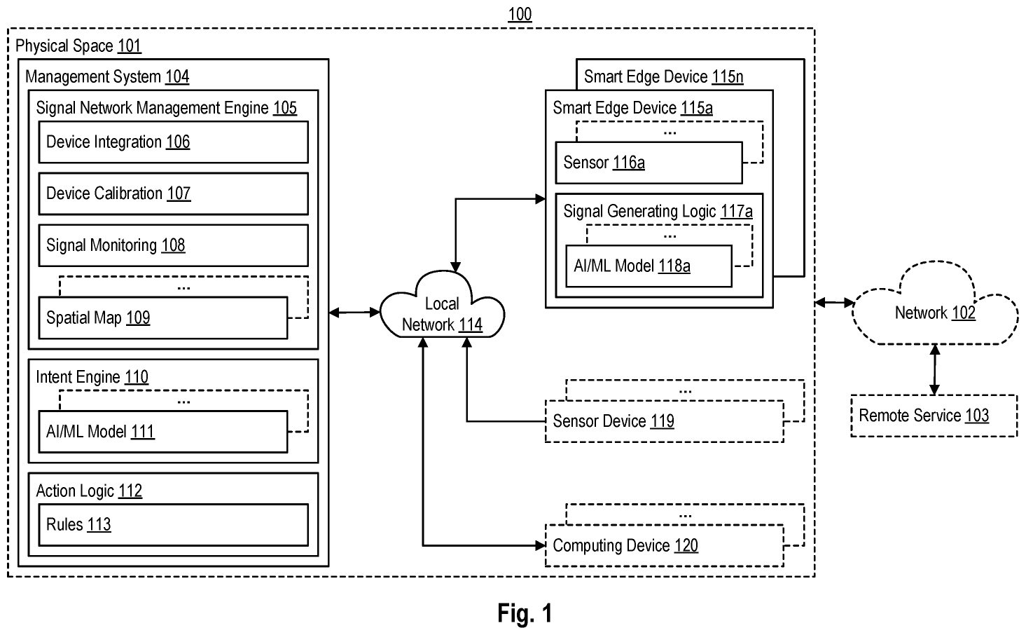

FIG. 1 illustrates an example computing environment 100 that facilitates automatically forming and using a local network of smart edge devices. As shown, computing environment 100 includes a management system 104 and a plurality of smart edge devices (i.e., smart edge device 115a to smart edge device 115n) located within a physical space 101, and interconnected by a local network 114 (e.g., a local area network). In embodiments, the physical space 101 is a local premises, such as an office building (or a group of office buildings), a warehouse, a store, a home, an outdoor space, and the like.

In some embodiments, the management system 104 is interconnected to a remote service 103 via a network 102 (e.g., a wide area network, such as the Internet). In embodiments, the remote service 103 provides one or more services to the management system 104, such as software updates for one or more components at the management system 104, communication of alerts from the management system 104 to a system outside of the physical space 101, remote management of the management system 104, and the like.

The smart edge devices each includes a sensor for sensing information about the physical space 101. For example, FIG. 1 illustrates smart edge device 115a as including a sensor 116a (or a corresponding plurality of sensors). As examples, a sensor could comprise a digital imaging sensor (camera), a light detector, a motion detector, a microphone, a pressure detector, a chemical detector (e.g., carbon monoxide, pH), and the like.

Additionally, the smart edge devices each includes signal generating logic for processing sensor information, in order to generate “physical” signals associated with the physical space 101 (including objects contained therein). In embodiments, the signal generating logic at each of the smart edge devices feeds sensor information to an artificial intelligence (AI) and/or machine learning (ML) model, in order to generate these physical signals. For example, FIG. 1 illustrates smart edge device 115a as including signal generating logic 117a, which in turn comprises an AI/ML model 118a (or a plurality of AI/ML models). In embodiments, the signal generating logic 117a feeds sensor information from the sensor 116a to the AI/ML model 118a, and the AI/ML model 118a and generates physical signals.

In embodiments, a physical signal describes an attribute of the physical space 101 itself; as examples, a physical signal may describe physical dimensions of the physical space 101, ambient readings of the physical space (e.g., temperature, sound level, light level, etc.), and the like. Additionally, or alternatively, in embodiments a physical signal describes an attribute of an object detected within the physical space 101; as examples, a physical signal may identify an object detected within the physical space 101 (e.g., a person generally, a particular person's identity, an animal, a commercial good, etc.), a position of an object detected within the physical space 101, a velocity vector of an object detected within the physical space 101, a temperature of an object detected within the physical space 101, a sound generated by an object detected within the physical space 101, whether a person detected within the physical space 101 is happy or sad, whether a person detected within the physical space 101 is performing a given gesture (e.g., a hand or head position), a number of people detected within the physical space 101, and the like.

In embodiments, computing environment 100 also includes a sensor device 119 (or a plurality of sensor devices) located within a physical space 101, and interconnected by the local network 114 to the management system 104. In embodiments, the sensor device 119 is a sensor (camera, light detector, motion detector, microphone, pressure detector, chemical detector) the generates and sends sensor information to the management system 104 via the local network 114, without first processing that sensor information with its own signal generating logic to generate physical signals.

In embodiments, computing environment 100 also includes a computing device 120 (or a plurality of computing devices) located within a physical space 101, and interconnected by the local network 114 to the management system 104. In embodiments, computing device 120 is a computing device (e.g., network switch, laptop computer, desktop computer, smartphone, etc.) that either lacks a sensor for sensing the physical space 101, or that does not send sensor information (or signals related thereto) to the management system 104. Thus, computing device 120 is also referred to herein as a non-sensor computing device. In embodiments, the management system 104 actively (e.g., via probing of the computing device 120, via reports from an agent installed on the computing device 120) or passively (e.g., by observation of traffic on the local network 114) monitors operation of the computing device 120 and generates “digital” signals relating to that operation. As examples, a digital signal may comprise and indication of credential validation failures at the computing device 120, an indication of network port scanning activity by the computing device 120, and the like.

The management system 104 is illustrated as including a signal network management engine 105 (hereinafter, management engine 105). In general, the management engine 105 provides a plug-and-play architecture for automatically adding newly discovered smart edge devices to a local network of smart edge devices, to automatically manage (e.g., recalibrate) those smart edge devices, and to facilitate local processing of signals generated by those smart edge devices.

As shown, the management engine 105 includes a device integration component 106. In embodiments, the device integration component 106 discovers new smart edge devices (e.g., smart edge device 115a to smart edge device 115n) within the physical space 101, and automatically adds each of those devices to a spatial map 109 (or a plurality of spatial maps) associated with the physical space 101. In some embodiments, the device integration component 106 starts with no spatial map of the physical space 101 and instantiates spatial map 109 (including, for example, establishing a coordinate system for the spatial map 109). In some embodiments, the device integration component 106 starts with an empty spatial map of the physical space 101. Either way, the device integration component 106 populates the spatial map 109 with smart edge devices (e.g., their positions, their attributes such as sensor capabilities, and the like) as those devices are discovered within the physical space 101.

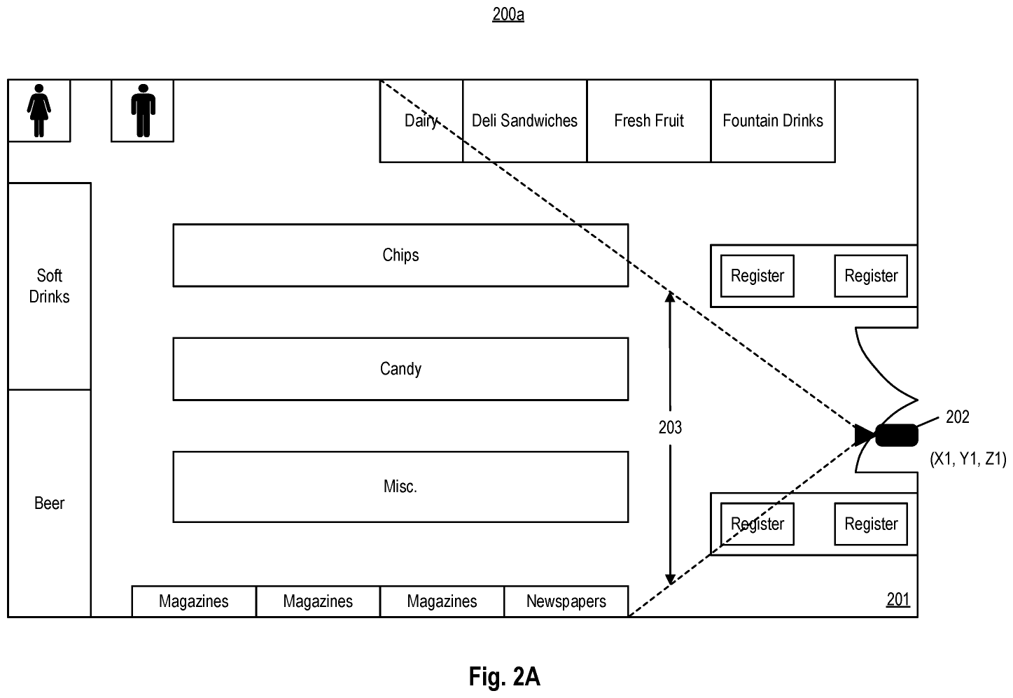

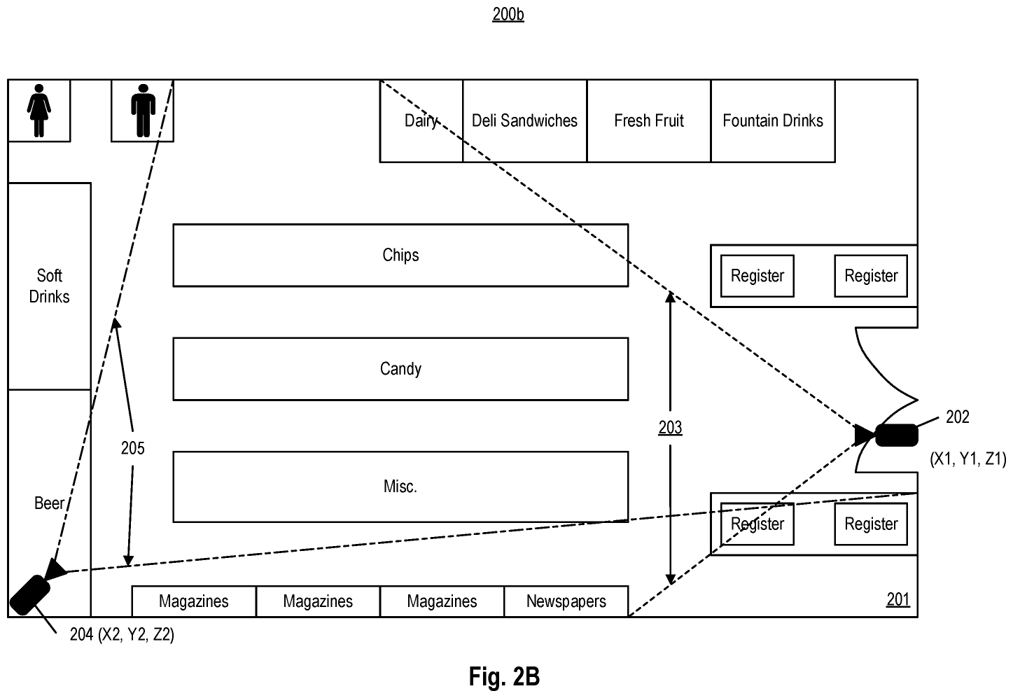

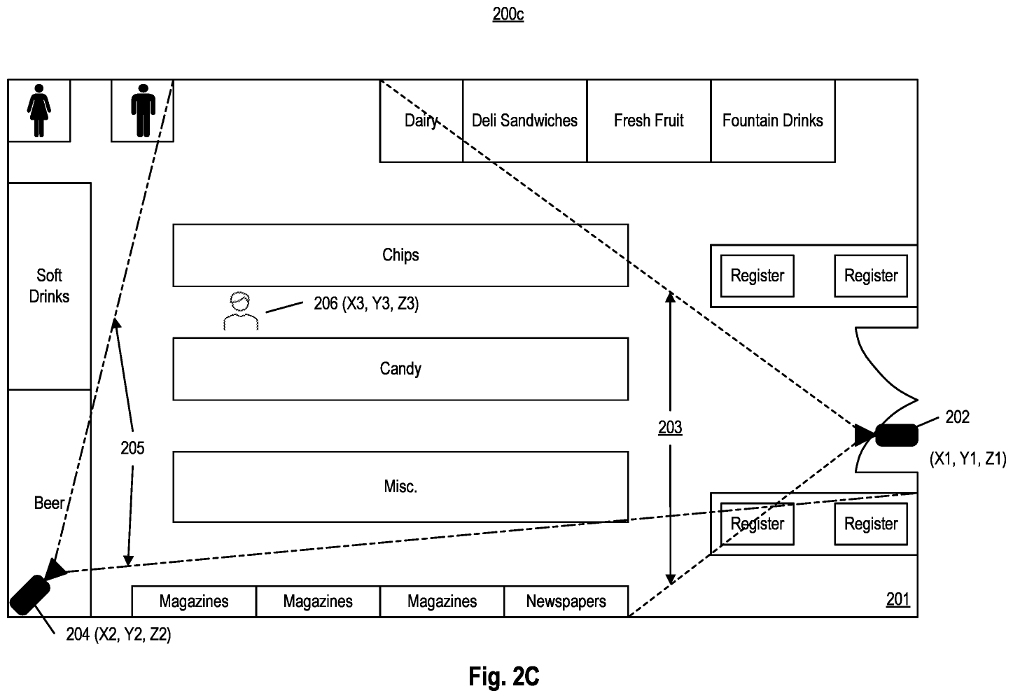

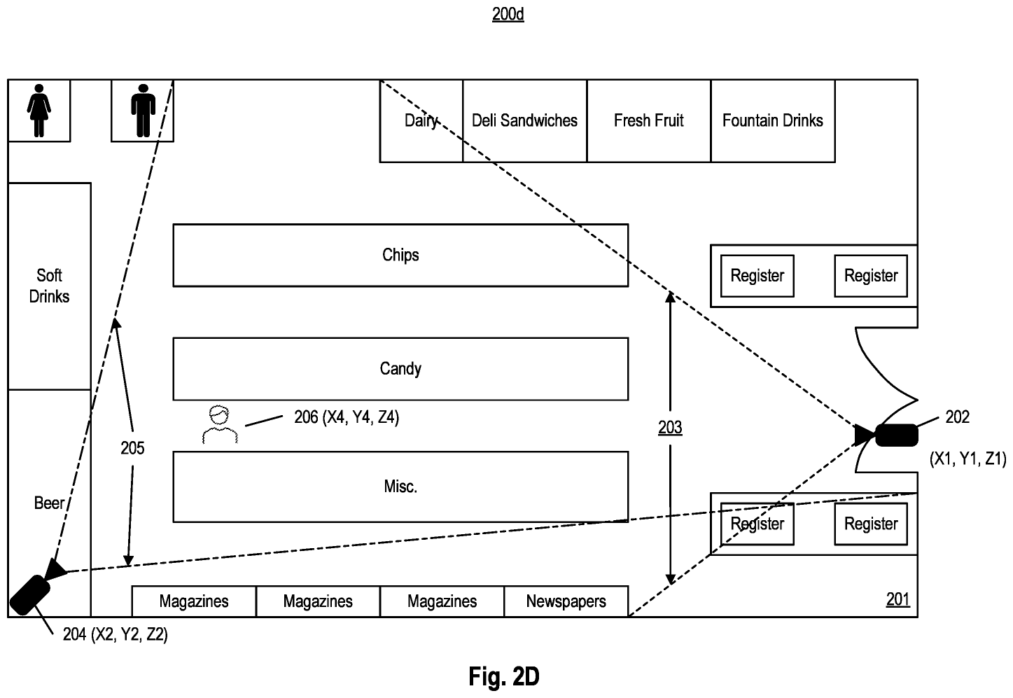

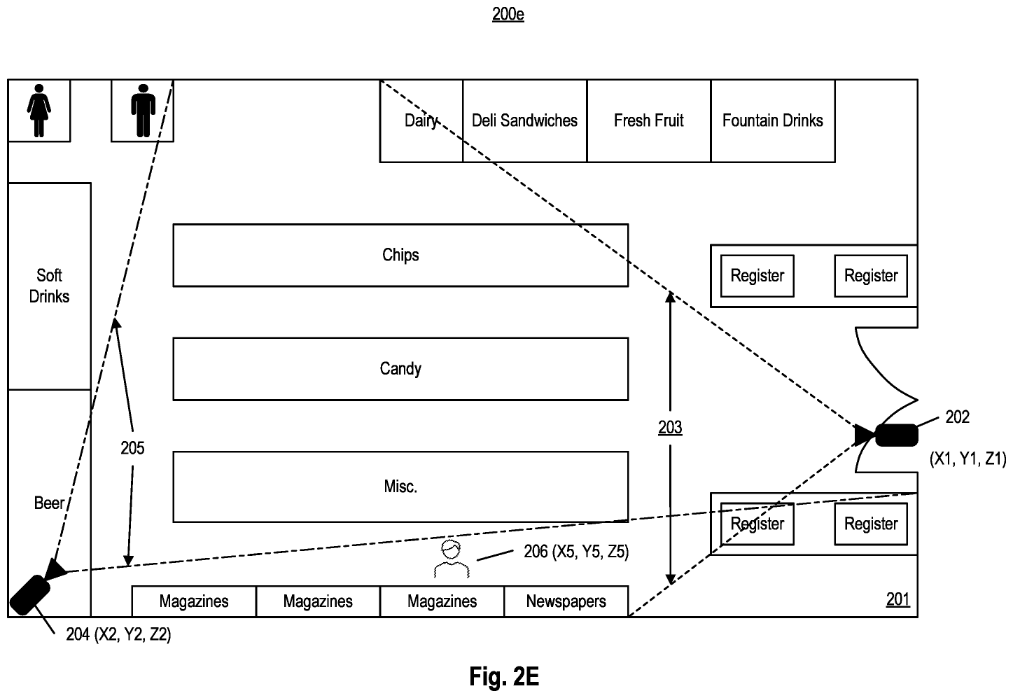

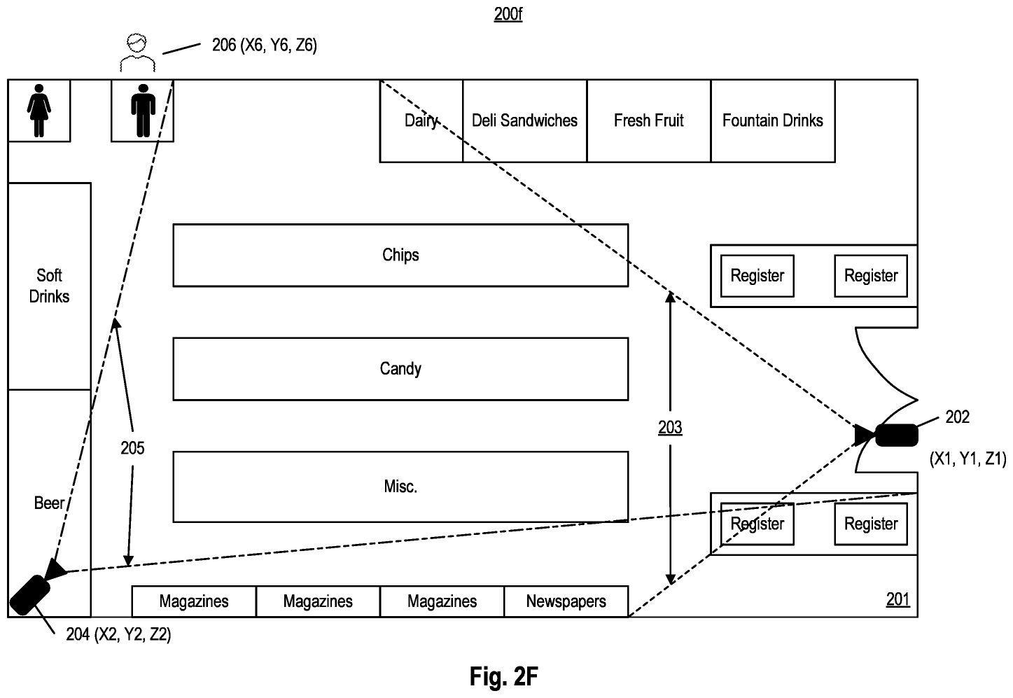

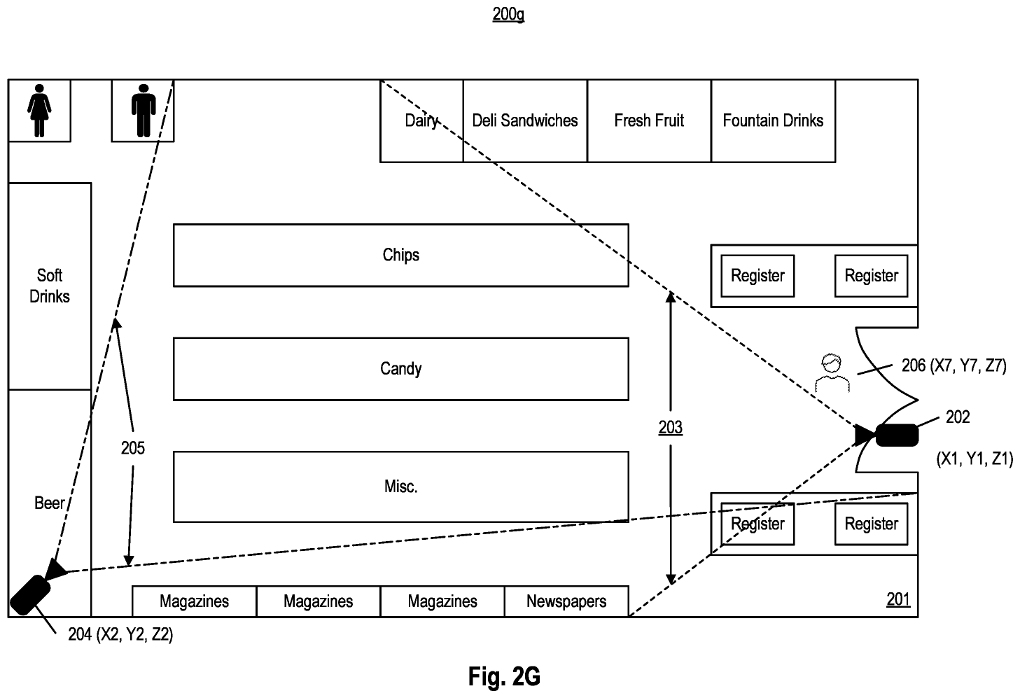

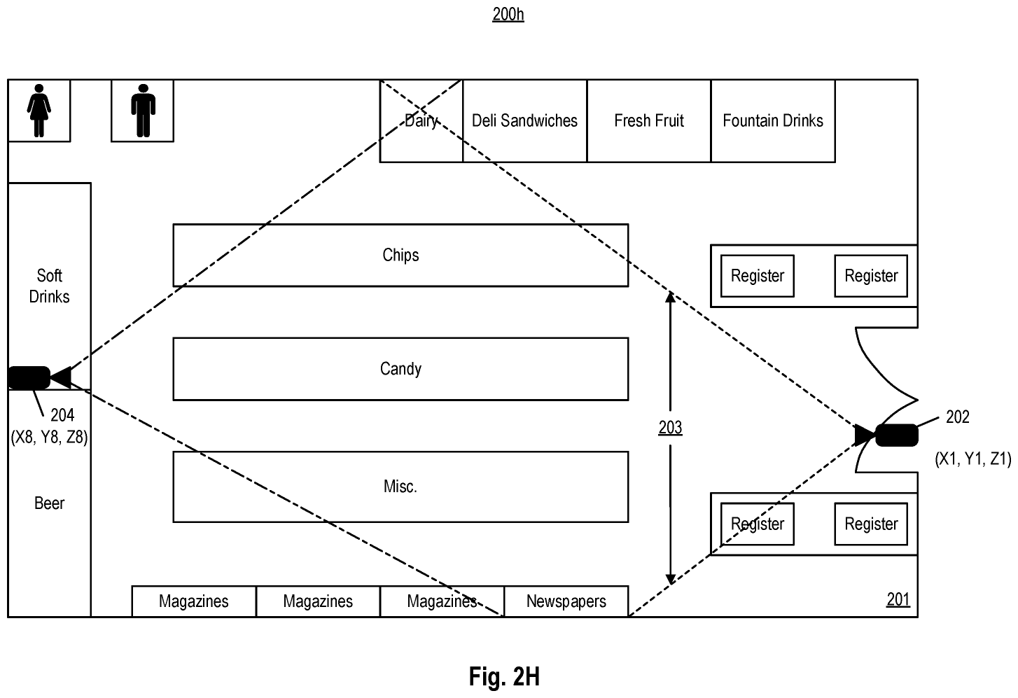

In embodiments, the device integration component 106 discovers an initial smart edge device (e.g., smart edge device 115a), and adds that smart edge device to the spatial map 109 with an initial (e.g., base) coordinate. For example, FIG. 2A illustrates an example 200a of integration of an initial smart edge device into a physical space. Example 200a illustrates a physical space 201 in the form a convenience store, with a smart camera 202 having been installed within the physical space 201. As shown, smart camera 202 has a field of view 203 that is indicated by dashed lines. In one example, the smart camera 202 is the smart edge device 115a from computing environment 100, and the sensor 116a of smart edge device 115a is a digital imaging sensor. In embodiments, upon discovery of this smart camera 202 within the physical space 201, the device integration component 106 inserts a coordinate of the smart camera 202—i.e., (X1, Y1, Z1)—into a spatial map 109 for the physical space 201.

Returning to FIG. 1, the management engine 105 also includes a device calibration component 107. In embodiments, for each smart edge device that is populated into the spatial map 109, the device calibration component 107 identifies a normal environmental state within the physical space 101 for that smart edge device. In embodiments, each smart edge device is initially uncalibrated (e.g., having an unknown sensor/signal state), and the device calibration component 107 determines a normal environmental state the smart edge device based on signals received from the device. For instance, based on signals received from the smart camera 202, the device calibration component 107 determines one or more attributes of physical space 201 that are normal for the smart camera 202. As examples, normal attributes of a physical space can include typical luminance levels detected by a sensor, typical audio levels detected by a sensor, typical temperatures detected by a sensor, the positions of static objects within a camera's field of view, an angle of inclination of the smart edge device, and the like.

In embodiments, since the device calibration component 107 determines normal environmental state on a per-device basis, those devices need not have consistent manufacturers or manufacturing tolerances. For example, due to loose manufacturing tolerances, two smart edge devices could read widely different temperatures within the same physical space. Nonetheless, the device calibration component 107 can determine a normal temperature reading for each smart edge device.

In embodiments, the device calibration component 107 determines normal environmental state for one or more smart edge devices using multiple dimensions of sensor signals (e.g., a combination of audio, lighting, temperature, etc.). Thus, in embodiments, the device calibration component 107 determines a hyper-personalized normal environmental state for each smart edge device.

In embodiments, the device integration component 106 discovers one or more additional smart edge devices (e.g., smart edge device 115n), and adds those smart edge device(s) to the spatial map 109 in reference to an already known smart edge device. Additionally, the device calibration component 107 identifies a normal environmental state for each of those additional smart edge devices. For example, FIG. 2B illustrates an example 200b of integration of an additional smart edge device into a physical space. Example 200b illustrates the physical space 201 from example 200a, including a smart camera 202 (e.g., smart edge device 115a) that the device integration component 106 has already added to the spatial map 109. In example 200b, however, a smart camera 204 has also been installed into the physical space 201. As shown, smart camera 204 has a field of view 205 that is indicated by dash-dot lines. In one example, the smart camera 204 is the smart edge device 115n from computing environment 100, and smart edge device 115n also comprises a digital imaging sensor. In embodiments, upon discovery of this smart camera 204 within the physical space 201, the device integration component 106 inserts a coordinate of smart camera 204—i.e., (X2, Y2, Z2)—into the spatial map 109 for the physical space 201, and the device calibration component 107 uses signals received from smart camera 204 to determine a normal environmental state for smart camera 204.

As mentioned, the device integration component 106 adds additional smart edge device(s) to the spatial map 109 in reference to an already known smart edge device. In embodiments, the device integration component 106 determines the relative position of one smart edge device (e.g., smart edge device 115n) to another smart edge device (e.g., smart edge device 115a) based on sets of signals received from one, or both, of these smart edge devices that indicate the presence of the other smart edge device. For instance, in example 200b, smart camera 204 is within the field of view 203 of smart camera 202; thus, a first set of signals received from smart camera 202 indicate the presence of smart camera 204. Additionally, in example 200b, smart camera 202 is within the field of view 205 of smart camera 204; thus, a second set of signals received from smart camera 204 indicate the presence of smart camera 202. Using one, or both, of the first and second sets of signals, the device integration component 106 can determine the relative positions of smart camera 202 and smart camera 204 within physical space 201.

In embodiments, the device integration component 106 also adds a sensor device 119 (i.e., non-smart) and/or a computing device 120 (i.e., non-sensor) to the spatial map 109. For example, a smart edge device detects a position of sensor device 119 or a computing device 120, and the device integration component 106 adds that device to the spatial map 109.

Returning to FIG. 1, the management engine 105 also includes a signal monitoring component 108. In embodiments, the signal monitoring component 108 monitors signals received from the smart edge devices, potentially in combination with signals generated based on the sensor device 119 and/or the computing device 120. In embodiments, the signal monitoring component 108 uses these signals to determine that there is an object within the physical space 101 (including, for example, its type, its identity, its position, and the like).

In embodiments, the signal monitoring component 108 combines signals from a plurality of smart edge devices to identify a single object within the physical space 101. For example, even though the same object may be observed/detected by each of the plurality of smart edge devices, the signal monitoring component 108 identifies a single object, rather than a different object for each smart edge device.

In embodiments, the signal monitoring component 108 tracks a time series for each identified object. Thus, for example, the signal monitoring component 108 tracks a position of a given object over time to develop a time series of object positions.

FIGS. 2C-2E illustrate examples of using a plurality of smart edge devices to detect and track a time series for a single object within a physical space. Referring to FIG. 2C, example 200c shows that, based on signals received from each of smart camera 202 and smart camera 204, the signal monitoring component 108 has identified a person 206 at coordinate (X3, Y3, Z3) within physical space 201. Referring to FIG. 2D, example 200d shows that, based on signals received from smart camera 202 and smart camera 204, the signal monitoring component 108 has determined that the person 206 has now moved to coordinate (X4, Y4, Z4) within physical space 201. Referring to FIG. 2E, example 200e shows that, based on signals received from smart camera 202, the signal monitoring component 108 has determined that the person 206 has now moved to coordinate (X5, Y5, Z5) within physical space 201. Thus, the signal monitoring component 108 has tracked a time series of at least three different positions of person 206 within the physical space 101.

As shown, the management system 104 also includes an intent engine 110 comprising an AI/ML model 111 (or a plurality of AI/ML models). In embodiments, the signal monitoring component 108 passes monitored signals for a given object to the intent engine 110. The intent engine 110, in turn, uses those signals as inputs to the AI/ML model 111 to determine one or more intents associated with that object. In embodiments, the intent engine 110 tracks a time series of intents for an object, such as a different set of intents for the object at each position tracked by the signal monitoring component 108. As examples, referring to FIGS. 2C-2E, the intent engine 110 may track an intent at coordinate (X3, Y3, Z3) for person 206 to pick a particular bag of chips (e.g., based on detecting a person grabbing bag of chips from the shelves), may track an intent at coordinate (X4, Y4, Z4) for person 206 to pick a particular box of candy (e.g., based on detecting the person grabbing the bag of candy from the shelves), and an intent at coordinate (X5, Y5, Z5) for person 206 to pick a particular magazine (e.g., based on detecting the person grabbing the magazine from the shelves).

In embodiments, the intent engine 110 tracks multiple levels of intents. In embodiments, based on a first level of intents associated with an object at each of a plurality of locations, the intent engine 110 determines a second level intent implied by the first level intents. For example, based on determining first-level intents for person 206 to pick a particular bag of chips, to pick a particular box of candy, and to pick a particular magazine, the intent engine 110 may determine that person 206 intends to purchase those items, that person 206 intends to steal those items, etc.

The management engine 105 also includes action logic 112, including rules 113. In embodiments, the action logic 112 applies the rules 113 to one or more intents determined by the intent engine 110 in order to determine if one or more actions are to be taken, and to initiate any determined actions (e.g., to call security, to turn on fire sprinkler, to lock a door, to generate an invoice, etc.). FIGS. 2F and 2G illustrate examples using a plurality of smart edge devices to determine actions based on an object within a physical space.

Referring to FIG. 2F, example 200f shows that, based on signals received from smart camera 202, the signal monitoring component 108 has identified a person 206 at coordinate (X6, Y6, Z6)—i.e., a bathroom associated with physical space 201. In embodiments, since the person 206 has picked the bag of chips, the box of candy, and the magazine, and since the person 206 has now moved to the bathroom, the intent engine 110 determines person 206 intends steal those items (e.g., by hiding those items in their jacket while in the bathroom). In embodiments, using the rules 113, the action logic 112 determines that an appropriate action is to send an alert (e.g., to a store employee). Thus, in embodiments, the action logic 112 initiates the alert.

Referring to FIG. 2G, example 200g shows that, based on signals received from smart camera 204, the signal monitoring component 108 has identified a person 206 at coordinate (X7, Y7, Z7)—i.e., leaving the physical space 201. In embodiments, since the person 206 has picked the bag of chips, the box of candy, and the magazine, and since the person 206 is now exiting the physical space 201, the intent engine 110 determines that person 206 intends purchase those items. In embodiments, using the rules 113, the action logic 112 determines that an appropriate action is to automatically invoice the person 206 and charge a credit card that is on file. Thus, in embodiments, the action logic 112 initiates the invoicing and credit card charge.

In embodiments, the device calibration component 107 also detects when a smart edge device has become uncalibrated (i.e., based on detecting abnormal environmental state for the smart edge device caused by a sensor deviation, a change in device position, a change in device angle, etc.), and initiates an automatic reconfiguration of the smart edge device. For example, FIG. 2H illustrates an example 200h recalibrating a normal environmental state for a smart edge device. In example 200h, smart camera 204 has been moved to a new coordinate (X8, Y8, Z8). Thus, the device calibration component 107 detects an abnormal environmental state for the smart camera 204 (e.g., the static objects within its field of view have changed). In embodiments, the device integration component 106 then updates a position of the smart camera 204 within the spatial map 109, and the device calibration component 107 identifies a new normal environmental state for the smart camera 204 at that position.

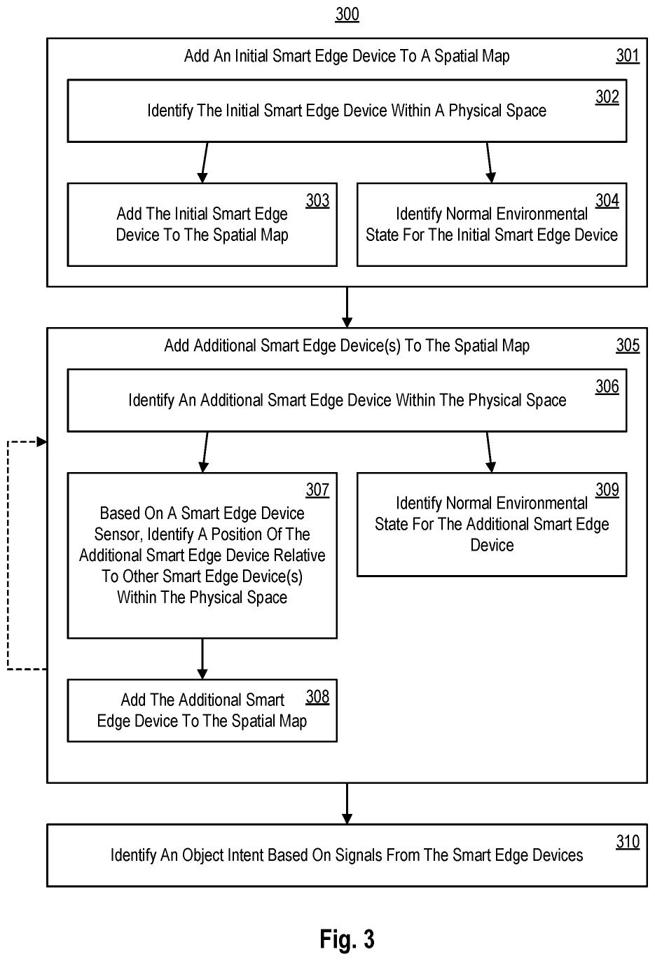

The components of the management engine 105 are now further described in connection with FIG. 3, which illustrates a flow chart of an example method 300 for forming and monitoring a network of smart edge sensor devices. In embodiments, instructions for implementing method 300 are encoded as computer-executable instructions (e.g., management engine 105) stored on a computer program product (e.g., a computer storage media) that are executable by a processor to cause a computer system (e.g., management system 104) to perform method 300.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

Referring to FIG. 3, in embodiments, method 300 comprises an act 301 of adding an initial smart edge device to a spatial map. As shown, act 301 comprises an act 302 of identifying the initial smart edge device within a physical space. Additionally, act 301 comprises an act 303 of adding the initial smart edge device to the spatial map, and an act 304 of identifying normal environmental state for the initial smart edge device. As shown, there is no express ordering requirement between act 303 and act 304. Thus, in various embodiments, those acts are performed serially (in either order), or at least partially in parallel.

In some embodiments, act 302 comprises identifying a first smart edge device within a physical space. In an example, and referring to FIG. 1, the device integration component 106 identifies smart edge device 115a located within physical space 101. In a specific example, and referring to FIG. 2A, the smart edge device 115a is the smart camera 202 located within physical space 201 (e.g., as illustrated in example 200a). In embodiments, identification of smart edge device 115a is based on the device integration component 106 communicating with the smart edge device 115a via the local network 114. In one example, based at least on joining local network 114, smart edge device 115a sends one or more packets over the local network 114 (e.g., identifying the smart edge device 115a as an un-joined smart edge device), and the device integration component 106 identifies those packet(s) to be part of a plug-and-play network communications protocol.

In some embodiments, act 303 comprises inserting a first coordinate of the first smart edge device into a spatial map associated with the physical space. Continuing the example of act 302, the device integration component 106 adds smart camera 202 to the spatial map 109 with initial/base coordinate (X1, Y1, Z1). As mentioned, in some embodiments, the device integration component 106 starts with no spatial map and instantiates the spatial map 109 (including, for example, establishing a coordinate system for the spatial map 109). Thus, some embodiments of act 303 instantiate the spatial map prior to inserting the first coordinate of the first smart edge device into the spatial map.

In some embodiments, act 304 comprises, based on a first sensor of the first smart edge device, identifying a first normal environmental state for the first smart edge device. Continuing the example of act 303, using signals received from the smart edge device 115a (i.e., based on the signal generating logic 117a processing sensor data generated by the sensor 116a), the device calibration component 107 identifies a normal environmental state for the smart edge device 115a. For instance, using signals generated by smart camera 202 the device calibration component 107 determines the size and/or positions of static objects that are within field of view 203—such as the sizes/positions of shelving units (e.g., for chips, candy, miscellaneous items, magazines, and newspapers), the sizes/positions of fridges (e.g., for beer and soft drinks), the sizes/positions of the entries to bathrooms, and the like.

Technical effects of act 301 (including act 302 to act 304) include automatically inserting an initial smart edge device to a spatial map, based on signals generated by that initial smart edge device, and automatically determining a normal environmental signal state for that initial smart edge device.

As mentioned, the device integration component 106 also adds at least one additional smart edge device (e.g., smart camera 204/smart edge device 115n) to the spatial map 109, and the device calibration component 107 identifies a normal environmental state for that additional smart edge device. Referring to FIG. 3, in embodiments, method 300 also comprises an act 305 of adding additional smart edge device(s) to the spatial map.

As shown, act 305 comprises an act 306 of identifying an additional smart edge device within the physical space. In some embodiments, act 306 comprises identifying a second smart edge device within the physical space. In an example, and referring to FIG. 1, the device integration component 106 identifies smart edge device 115n located within physical space 101. In a specific example, and referring to FIG. 2B, the smart edge device 115n is the smart camera 204 located within physical space 201. In embodiments, identification of smart edge device 115n is based on the device integration component 106 communicating with the smart edge device 115n via the local network 114.

After act 306, act 301 includes an act 307 of, based on a smart edge device sensor, identifying a position of the additional smart edge device relative to other smart edge device(s) within the physical space. Act 307 is followed by an act 308 of adding the additional smart edge device to the spatial map. After act 306, act 301 also includes an act 309 of identifying normal environmental state for the additional smart edge device. As shown, there is no express ordering requirement between acts 307/308 and act 309. Thus, in various embodiments, those acts are performed serially (in either order), or at least partially in parallel.

In some embodiments, act 307 comprises, based on identifying the second smart edge device within the physical space, identifying a position of the second smart edge device relative to the first smart edge device within the physical space. For example, referring to FIGS. 1 and 2B, the device integration component 106 identifies smart camera 204 within physical space 201 and identifies its position relative to smart camera 202. In embodiments, act 307 is based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device. In an example, a first set of signals received by the device integration component 106 from smart camera 202 indicate the presence of smart camera 204, and a second set of signals received from smart camera 204 indicate the presence of smart camera 202. Thus, using one, or both, of the first and second sets of signals, the device integration component 106 can determine the relative positions of smart camera 202 and smart camera 204 within physical space 201.

In some embodiments, act 308 comprises inserting a second coordinate of the second smart edge device into the spatial map associated with the physical space. Continuing the example of act 307, the device integration component 106 adds smart camera 204 to the spatial map 109 with coordinate (X2, Y2, Z2), which is relative to coordinate (X1, Y1, Z1) of smart camera 202.

In some embodiments, act 309 comprises, based on the second sensor of the second smart edge device, identifying a second normal environmental state for the second smart edge device. Continuing the example of act 308, using signals received from the smart edge device 115n, the device calibration component 107 identifies a normal environmental state for the smart edge device 115n. For instance, using signals generated by smart camera 204 the device calibration component 107 determines the size and/or positions of static objects that are within field of view 205—such as the sizes/positions of shelving units (e.g., for chips, candy, and miscellaneous items, the sizes/positions of fridges (e.g., for diary, deli sandwiches, and fresh fruit), the sizes/positions of fountain drinks, and the like.

A broken arrow shows that act 305 can repeat zero or more times to add any number of additional smart edge devices to the spatial map 109.

Technical effects of act 305 (including act 306 to act 309) include automatically inserting an additional smart edge device to a spatial map in reference to an already inserted smart edge device, and automatically determining a normal environmental signal state for that additional smart edge device.

Referring to FIG. 3, in embodiments, method 300 also comprises an act 310 of identifying an object intent based on signals from the smart edge devices. In some embodiments, act 310 comprises, based on at least on monitoring a first signal stream generated by the first signal generating logic, and on monitoring a second signal stream generated by the second signal generating logic, identifying a set of one or more intents associated with an object positioned within the physical space. In an example, FIGS. 2C to 2E illustrate that the signal monitoring component 108 monitors signals from the smart camera 202 and the smart camera 204 to detect and track a time series of positions for person 206. Additionally, the intent engine 110 tracks intents for this person 206 at each position, such as to pick chips, candy, and a magazine.

As mentioned, in embodiments the intent engine 110 uses an AL/ML model 111 in order to process signals and determine intents for an object. Thus, in some embodiments of act 310, identifying the set of one or more intents associated with the object positioned within the physical space comprises sending, to an Al or ML model of an intent engine, at least the first signal stream and the second signal stream.

As mentioned, in embodiments smart edge devices generate “physical” associated with a physical space (including objects contained therein), while the management system 104 actively or passively monitors operation of a computing device 120 to generates “digital” signals relating to its operation. In embodiments, the intent engine 110 utilizes both physical and digital signals, together, to determine intent for a given object. For example, the intent engine 110 may determine an intent of a on-premises network intrusion by a particular person, based on a physical signal indicating that the particular person is at a computer (e.g., computing device 120), and a digital signal indicating that there is a port scan originating from that computer. Thus, in some embodiments of method 300, the first signal stream comprises a first physical signal associated with the object positioned within the physical space; the second signal stream comprises a second physical signal associated with the object positioned within the physical space; and identifying the set of one or more intents associated with the object positioned within the physical space comprises sending, to an Al or ML model of an intent engine, at least (i) the first physical signal, (ii) the second physical signal, and (iii) a digital signal associated with a non-sensor computing device.

As mentioned, in embodiments the action logic 112 utilizes rules 113 to determine an action, and initiate that action, based on intents determined by the intent engine 110. Thus, in some embodiments, method 300 also includes, in response to identifying the set of one or more intents associated with the object positioned within the physical space, determining an action based on a set of one or more rules, and automatically initiating the action.

As mentioned, in embodiments the signal monitoring component 108 combines signals from a plurality of smart edge devices to identify a single object within a physical space. Thus, in some embodiments, method 300 also includes, based the first signal stream, detecting a first object positioned within the physical space; based the second signal stream, detecting a second object positioned within the physical space; and determining that the object positioned within the physical space corresponds to each of the first object and the second object.

As mentioned, in embodiments the signal monitoring component 108 tracks a time series of positions for each identified object, and the intent engine 110 tracks a time series of intents for the object. Thus, in some embodiments, method 300 also includes determining a time series for the object positioned within the physical space, the time series including at least one of object position or object intent.

As mentioned, in embodiments the intent engine 110 tracks multiple levels of intents for an object. Thus, in some embodiments, method 300 also includes determining a second-level intent for the object positioned within the physical space from the set of one or more intents.

As mentioned, in embodiments the device calibration component 107 detects when a smart edge device has become uncalibrated, and initiates an automatic reconfiguration of the smart edge device. As such, in some embodiments, method 300 also includes, based on identifying a first anomalous signal from the first smart edge device, recalibrating the first normal environmental state for the first smart edge device; or based on identifying a second anomalous signal from the second smart edge device, recalibrating the second normal environmental state for the second smart edge device.

As mentioned, in embodiments the device integration component 106 can add a non-sensor computing device (e.g., computing device 120) to the spatial map 109. As such, in some embodiments, method 300 also includes identifying a non-sensor computing device within the physical space, and inserting a third coordinate of the non-sensor computing device into the spatial map associated with the physical space.

As mentioned, smart edge devices comprise signal generating logic (e.g., signal generating logic 117a) that uses an AI/ML model (e.g., AI/ML model 118a) to process raw sensor data locally and generate signal data. Thus, in some embodiments of method 300, the first signal stream is generated by the first signal generating logic based on processing first sensor data generated by the first sensor of the first smart edge device through a first Al or ML model at the first smart edge device, and the second signal stream is generated by the second signal generating logic based on processing second sensor data generated by the second sensor of the second smart edge device through a second Al or ML model at the second smart edge device.

Accordingly, the embodiments described herein automatically form and use a local network of smart edge devices. This includes using an automated plug-and-play architecture to automatically detect the presence of new smart edge device, to add each detected smart edge device to a spatial map of a local physical space, to determine a normal environmental signal state for each detected smart edge device. This also includes automatically determining when the environmental signal state for a given smart edge device has changed) and then determining a new normal environmental signal state for the smart edge device. This also includes locally processing signals received from smart edge device at a local premises, rather than in the cloud.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its essential characteristics. Such embodiments may include a data processing device comprising means for carrying out one or more of the methods described herein; a computer program comprising instructions which, when the program is executed by a computer, cause the computer to carry out one or more of the methods described herein; and/or a computer-readable medium comprising instructions which, when executed by a computer, cause the computer to carry out one or more of the methods described herein. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A computer system comprising:
a processor; and
a computer storage media that stores computer-executable instructions that are executable by the processor to cause the computer system to at least:
based on identifying a first smart edge device within a physical space:
insert a first coordinate of the first smart edge device into a spatial map associated with the physical space, and
based on a first sensor of the first smart edge device, identify a first normal environmental state for the first smart edge device;
based on identifying a second smart edge device within the physical space:
identify a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device,
insert a second coordinate of the second smart edge device into the spatial map associated with the physical space, and
based on the second sensor of the second smart edge device, identify a second normal environmental state for the second smart edge device; and
based on at least on monitoring a first signal stream generated by the first signal generating logic, and on monitoring a second signal stream generated by the second signal generating logic, identify a set of one or more intents associated with an object positioned within the physical space.

2. The computer system of claim 1, wherein identifying the set of one or more intents associated with the object positioned within the physical space comprises:
sending, to an artificial intelligence or machine learning model of an intent engine, at least the first signal stream and the second signal stream.

3. The computer system of claim 1, wherein:
the first signal stream comprises a first physical signal associated with the object positioned within the physical space;
the second signal stream comprises a second physical signal associated with the object positioned within the physical space; and
identifying the set of one or more intents associated with the object positioned within the physical space comprises sending, to an artificial intelligence or machine learning model of an intent engine, at least (i) the first physical signal, (ii) the second physical signal, and (iii) a digital signal associated with a non-sensor computing device.

4. The computer system of claim 1, wherein the computer-executable instructions are also executable by the processor to cause the computer system to:
in response to identifying the set of one or more intents associated with the object positioned within the physical space, determine an action based on a set of one or more rules; and
automatically initiate the action.

5. The computer system of claim 1, wherein the computer-executable instructions are also executable by the processor to cause the computer system to:
based the first signal stream, detect a first object positioned within the physical space;
based the second signal stream, detect a second object positioned within the physical space; and
determine that the object positioned within the physical space corresponds to each of the first object and the second object.

6. The computer system of claim 1, wherein the computer-executable instructions are also executable by the processor to cause the computer system to:
determine a time series for the object positioned within the physical space, the time series including at least one of object position or object intent.

7. The computer system of claim 1, wherein the computer-executable instructions are also executable by the processor to cause the computer system to:
determine a second-level intent for the object positioned within the physical space from the set of one or more intents.

8. The computer system of claim 1, the computer-executable instructions are also executable by the processor to cause the computer system to perform at least one of:
based on identifying a first anomalous signal from the first smart edge device, recalibrate the first normal environmental state for the first smart edge device; or
based on identifying a second anomalous signal from the second smart edge device, recalibrate the second normal environmental state for the second smart edge device.

9. The computer system of claim 1, wherein the computer-executable instructions are also executable by the processor to cause the computer system to:
instantiate the spatial map prior to inserting the first coordinate of the first smart edge device into the spatial map.

10. The computer system of claim 1, wherein the computer-executable instructions are also executable by the processor to cause the computer system to:
identify a non-sensor computing device within the physical space; and
insert a third coordinate of the non-sensor computing device into the spatial map associated with the physical space.

11. The computer system of claim 1, wherein:
the first signal stream is generated by the first signal generating logic based on processing first sensor data generated by the first sensor of the first smart edge device through a first artificial intelligence or machine learning model at the first smart edge device; and
the second signal stream is generated by the second signal generating logic based on processing second sensor data generated by the second sensor of the second smart edge device through a second artificial intelligence or machine learning model at the second smart edge device.

12. A method, implemented at a computer system that includes a processor, for forming and monitoring a network of smart edge sensor devices, the method comprising:
based on identifying a first smart edge device within a physical space:
inserting a first coordinate of the first smart edge device into a spatial map associated with the physical space, and
based on a first sensor of the first smart edge device, identifying a first normal environmental state for the first smart edge device;
based on identifying a second smart edge device within the physical space:
identifying a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device,
inserting a second coordinate of the second smart edge device into the spatial map associated with the physical space, and
based on the second sensor of the second smart edge device, identifying a second normal environmental state for the second smart edge device; and
based on at least on monitoring a first signal stream generated by the first signal generating logic, and on monitoring a second signal stream generated by the second signal generating logic, identifying a set of one or more intents associated with an object positioned within the physical space.

13. The method of claim 12, wherein identifying the set of one or more intents associated with the object positioned within the physical space comprises:
sending, to an artificial intelligence or machine learning model of an intent engine, at least the first signal stream and the second signal stream.

14. The method of claim 12, wherein:
the first signal stream comprises a first physical signal associated with the object positioned within the physical space;
the second signal stream comprises a second physical signal associated with the object positioned within the physical space; and
identifying the set of one or more intents associated with the object positioned within the physical space comprises sending, to an artificial intelligence or machine learning model of an intent engine, at least (i) the first physical signal, (ii) the second physical signal, and (iii) a digital signal associated with a non-sensor computing device.

15. The method of claim 12, further comprising:
in response to identifying the set of one or more intents associated with the object positioned within the physical space, determining an action based on a set of one or more rules; and
automatically initiating the action.

16. The method of claim 12, further comprising:
based the first signal stream, detecting a first object positioned within the physical space;
based the second signal stream, detecting a second object positioned within the physical space; and
determining that the object positioned within the physical space corresponds to each of the first object and the second object.

17. The method of claim 12, further comprising:
determining a second-level intent for the object positioned within the physical space from the set of one or more intents.

18. The method of claim 12, further comprising at least one of:
based on identifying a first anomalous signal from the first smart edge device, recalibrating the first normal environmental state for the first smart edge device; or
based on identifying a second anomalous signal from the second smart edge device, recalibrating the second normal environmental state for the second smart edge device.

19. The method of claim 12, further comprising:
identifying a non-sensor computing device within the physical space; and
inserting a third coordinate of the non-sensor computing device into the spatial map associated with the physical space.

20. A computer program product comprising a computer storage media that stores computer-executable instructions that are executable by a processor to cause a computer system to at least:
based on identifying a first smart edge device within a physical space:
insert a first coordinate of the first smart edge device into a spatial map associated with the physical space, and
based on a first sensor of the first smart edge device, identify a first normal environmental state for the first smart edge device;
based on identifying a second smart edge device within the physical space:
identify a position of the second smart edge device relative to the first smart edge device within the physical space, based on at least one of (i) first signal generating logic of the first smart edge device generating a first signal associated with sensing the second smart edge device by the first sensor, or (ii) second signal generating logic of the second smart edge device generating a second signal associated with sensing the first smart edge device by a second sensor of the second smart edge device,
insert a second coordinate of the second smart edge device into the spatial map associated with the physical space, and
based on the second sensor of the second smart edge device, identify a second normal environmental state for the second smart edge device; and
based on at least on monitoring a first signal stream generated by the first signal generating logic, and on monitoring a second signal stream generated by the second signal generating logic, identify a set of one or more intents associated with an object positioned within the physical space.
